(19) United States
(12) Patent Application Publication
(10) Pub. No.: US 2025/0022116 A1
(43) Pub. Date: Jan. 16, 2025

(54) MASK IMAGE GENERATION METHOD, INSPECTION METHOD, AND INSPECTION APPARATUS

(71) Applicant: Hitachi Astemo, Ltd., Ibaraki (JP)

(72) Inventors: Hideaki ONOZUKA, Hitachinaka-shi, Ibaraki (JP); Takamasa IMAIZUMI, Hitachinaka-shi, Ibaraki (JP); Hiroyuki HAYASHI, Hitachinaka-shi, Ibaraki (JP)

(21) Appl. No.: 18/714,260

(22) PCT Filed: Dec. 5, 2022
(86) PCT No.: PCT/JP2022/044716

§ 371 Date: May 29, 2024

(30) Foreign Application Priority Data
Dec. 6, 2021 (JP) 2021-197538

(51) Int. Cl. G06T 7/00; G06T 7/11; G06T 15/10

(52) U.S. Cl. CPC G06T 7/0004; G06T 7/11; G06T 15/10; G06T 2207/20081; G06T 2207/20084; G06T 2207/30164

(57) ABSTRACT

One aspect of the present invention acquires a plurality of virtual images when an imaging target is imaged by a virtual imaging portion while a posture of three-dimensional data is changed to each of a plurality of specific postures.

### TECHNICAL FIELD

The present invention relates to a mask image generation method, an inspection method, and an inspection apparatus.

### BACKGROUND ART

An inspection method disclosed in PTL 1 acquires a virtual image virtualizing that a workpiece is imaged based on the position and the direction of an arm of an articulated robot, three-dimensional data indicating the shape of the workpiece, and the position and the direction of the workpiece, and generates a mask image that masks a part of an actual image based on this virtual image.

### CITATION LIST

### Patent Literature

PTL 1: Japanese Patent Application Laid-Open No. 2012-22600

### SUMMARY OF INVENTION

### Technical Problem

However, when imaging a three-dimensional curved surface while tilting it, the inspection method of PTL 1 may fail to accurately generate the mask image when an inspection region is hidden due to unevenness of the surface of the imaging target depending on the posture.

One of objects of the present invention is to provide a mask image generation method, an inspection method, and an inspection apparatus capable of accurately generating a mask image even when imaging a three-dimensional curved surface while tilting it.

### Solution to Problem

According to one aspect of the present invention, a mask image generation method acquires a plurality of virtual images when an imaging target is imaged by a virtual imaging portion while a posture of three-dimensional data is changed to each of a plurality of specific postures.

According to the one aspect of the present invention, a mask image can be accurately generated even when a three-dimensional curved surface is imaged while tilted.

### BRIEF DESCRIPTION OF DRAWINGS

FIG. 1 is a schematic view of a visual inspection apparatus 1 according to a first embodiment.

FIG. 2 is a flowchart illustrating a flow of result candidate detection processing in a visual inspection method according to the first embodiment.

FIG. 3 illustrates each of captured images (views 1 to 25).

FIG. 4 illustrates a mask image for each of the views when machined surfaces 11 and 12 are each set as an inspection region, and an as-cast surface 13 and a background 14 are each set as a non-inspection region.

FIG. 5 illustrates a mask image for each of the views when the as-cast surface 13 is set as the inspection region and the machined surfaces 11 and 12 and the background 14 are each set as the non-inspection region.

FIG. 6 illustrates detection of a defect candidate in each of the views using a first AI.

FIG. 7 illustrates grouping of the same defect candidate in each of the views.

FIG. 8 is a flowchart illustrating a flow of mask image generation processing according to the first embodiment.

FIG. 9 illustrates a problem with a conventional mask image generation method.

FIG. 10 illustrates a function of removing an invisible inspection region in the mask image generation method according to the first embodiment.

FIG. 11 illustrates misalignment between a non-mask region in the mask image and the inspection region in the captured image.

FIG. 12 illustrates a function of correctively reducing the non-inspection region in the mask image generation method according to the first embodiment.

### DESCRIPTION OF EMBODIMENTS

### First Embodiment

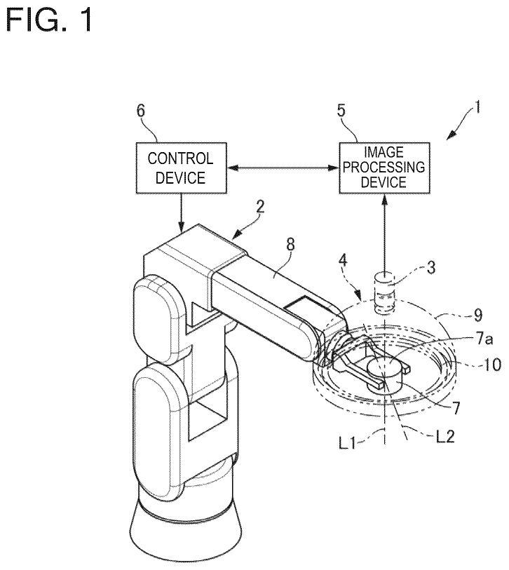

FIG. 1 is a schematic view of a visual inspection apparatus 1 according to a first embodiment.

The visual inspection apparatus 1 (hereinafter referred to as an inspection apparatus 1) includes a robot 2, a camera (an imaging portion) 3, an illumination device 4, an image processing device 5, and a control device 6. The robot 2 is an articulated robot, and includes a hand 8. The hand 8 holds an engine piston material or a machined finished product of an engine piston (hereinafter simply referred to as a piston) 7, which is an imaging target. The camera 3 is supported with a lens thereof facing vertically downward. The illumination device 4 irradiates a crown surface 7a of the piston 7 with light, and includes a dome 9 and ring illumination 10. The dome 9 houses the piston 7 and the ring illumination 10 therein. The dome 9 reflects/diffuses the light emitted from the ring illumination 10. The dome 9 is located vertically below the camera 3, and is fixed integrally with the camera 3. The camera 3 images the crown surface 7a of the piston 7 from an opening portion provided at the upper end of the dome 9. The ring illumination 10 is annular LED illumination arranged so as to surround the piston 7. The ring illumination 10 is supported rotatably about the central axis of the camera 3 relative to the camera 3 and the dome 9 by a not-illustrated supporting device.

The image processing device 5 performs image processing of extracting a defect candidate portion from the surface image of the crown surface 7a imaged by the camera 3 (hereinafter simply referred to as a captured image), and generating, for example, an 8-bit (256 tones) gray-scale image from the defect candidate portion. The control device 6 outputs an instruction for changing an angle of view (a posture angle) of the crown surface 7a of the piston 7 relative to the camera 3 to the robot 2. Then, each angle of view is acquired by rotating the piston 7 in such a manner that a second axis L2 is rotated about a first axis L1 assuming that the first axis L1 refers to a straight line passing through the center of the piston 7 and extending vertically and the second axis L2 refers to a straight line inclined with respect to the first axis L1.

Further, the control device 6 outputs an instruction for imaging the crown surface 7a to the camera 3. The control device 6 acquires twenty-five gray-scale images (views 1 to 25) by imaging the crown surface 7a at twenty-five angles while changing the angle of view. Then, the control device 6 determines whether a defect (a cavity, a scratch, a dent, and/or the like) is present based on a pre-stored learning result according to a change in the luminance distribution of the same defect candidate in each of the views. The control device 6 stores a learning result of machine learning conducted using a plurality of defective product sample images. The machine learning is learning using a neural network, and learning based on deep learning is employed in the first embodiment. The plurality of defective product sample images is generated by synthesizing a two-dimensional image of a defect shape, which is generated by converting a defect model three-dimensionally, i.e., stereoscopically formulated in advance into a point cloud, with a surface image of the piston 7.

The defect is generated as a geometric enveloping surface, and the two-dimensional image of the defect shape is generated by adding luminance with respect to the defect model. At this time, the luminance with respect to the defect model is a luminance distribution in a predetermined range that contains a defect and a predetermined portion around the defect in the defect model. The defect specifically includes a cavity, a scratch, a dent, and a blister. Then, each defect includes a plurality of defects different in size. The luminance distribution is acquired based on the angle of a preset illumination direction at the coordinates of the point cloud of the surface in the predetermined range that is converted from the defect model, the angle of a preset imaging direction at the coordinates of the point cloud, and the angle of a normal direction to the defect in a plane containing the illumination direction and the imaging direction. The control device 6 generates the two-dimensional image of the defect shape based on the defect model, and generates the defective product sample image by synthesizing the two-dimensional image with the image of the crown surface 7a of the piston 7.

Now, the crown surface 7a of the piston 7 includes an as-cast surface in an as-cast state and a machined surface processed by machining, and they should be inspected under respective different conditions because the defect shape is different in shape and size therebetween due to a difference in characteristic such as surface roughness. For this reason, the image processing device 5 generates a mask image for masking a non-inspection region (a second region) in the surface image of each of the views of the crown surface 7a imaged by the camera 3, and inspects an inspection region (a first region) while masking the surface image with the mask image. The image processing device 5 generates a mask image for masking the as-cast surface and a background (a portion other than the crown surface 7a) when the machined surface is set as the inspection region, while generating a mask image for masking the machined surface and the background when the as-cast surface is set as the inspection region.

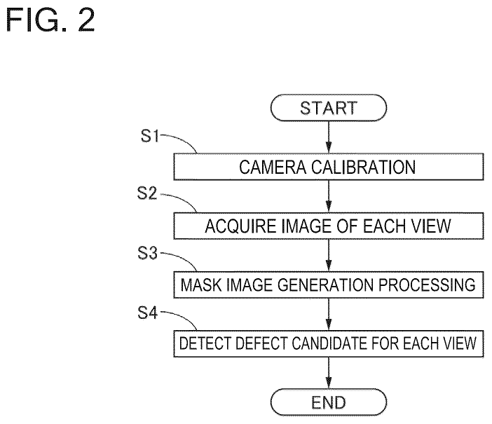

FIG. 2 is a flowchart illustrating a flow of result candidate detection processing in a visual inspection method according to the first embodiment.

In step S1, camera calibration is conducted using a calibration pattern such as a checkerboard, and an intrinsic parameter K, extrinsic parameters (a rotation element R_{N} and a translation element T_{N}, N=1 to 25), and a distortion coefficient of the camera 3 are estimated. The intrinsic parameter K is a parameter for a transformation from a camera coordinate system into an image coordinate system, and is dependent on the camera and the lens. The rotation element R_{N} and the translation element T_{N} are parameters for a transformation from a world coordinate system into the camera coordinate system, and are dependent on the angle of view. A perspective projection transformation equation P_{N}≡K(R_{N}|T_{N}) for transforming a position in the world coordinate system into a position in the image coordinate system is acquired based on the estimation of each of the parameters.

This step is performed only at the first time, and is not performed after the perspective projection transformation equation is acquired.

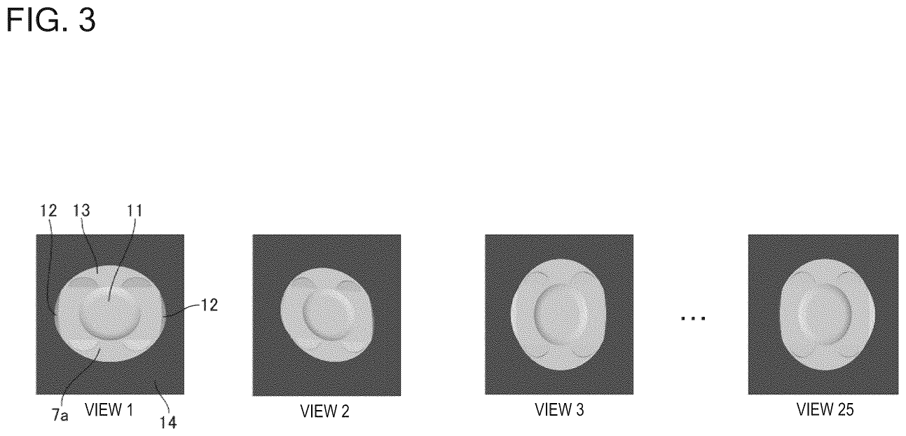

In step S2, the crown surface 7a is imaged at twenty-five angles while the angle of view is changed, and the captured images (the views 1 to 25), which are twenty-five actual images, are acquired as illustrated in FIG. 3. Now, the shape of the crown surface 7a will be described based on the captured images illustrated in FIG. 3. The crown surface 7a includes a first machined surface 11 and a pair of second machined surfaces 12 and 12. The first machined surface 11 is a circular recessed portion processed by machining, and is provided at the center of the crown surface 7a. The pair of second machined surfaces 12 and 12 is formed by chamfering processing, and is provided at symmetric positions with respect to the first machined surface 11. A generally annular region other than each of the machined surfaces 11 and 12 on the crown surface 7a is the as-cast surface 13. Further, a portion other than the crown surface 7a is assumed to be the background 14 in FIG. 3.

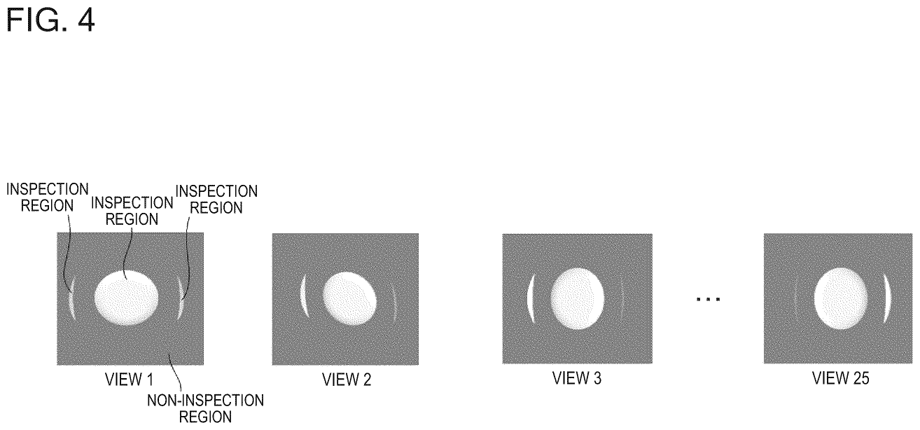

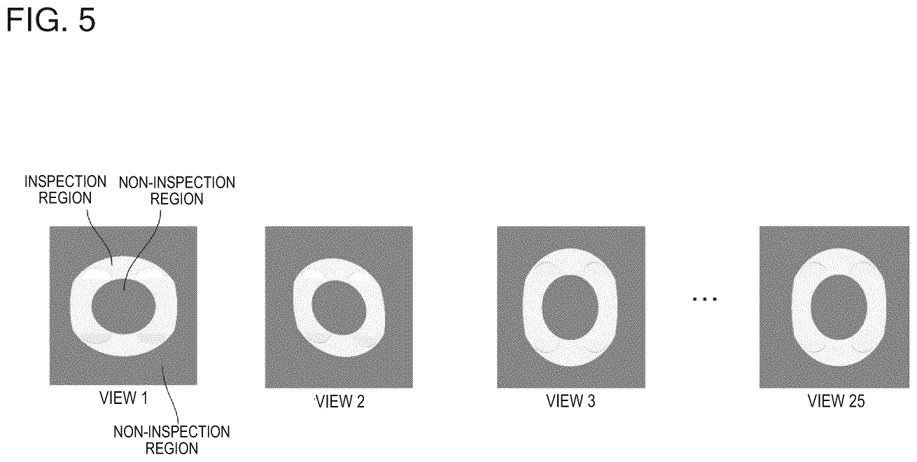

In step S3, mask image generation processing for generating the mask image for each of the views is performed. FIG. 4 illustrates the mask image for each of the views when the machined surfaces 11 and 12 are each set as the inspection region, and the as-cast surface 13 and the background 14 are each set as the non-inspection region. On the other hand, FIG. 5 illustrates the mask image for each of the views when the as-cast surface 13 is set as the inspection region and the machined surfaces 11 and 12 and the background 14 are each set as the non-inspection region. The details of the mask image generation processing will be described below. In the following description, the result candidate detection processing will be further described assuming that the machined surfaces 11 and 12 are each set as the inspection region, and the as-cast surface 13 and the background 14 are each set as the non-inspection region.

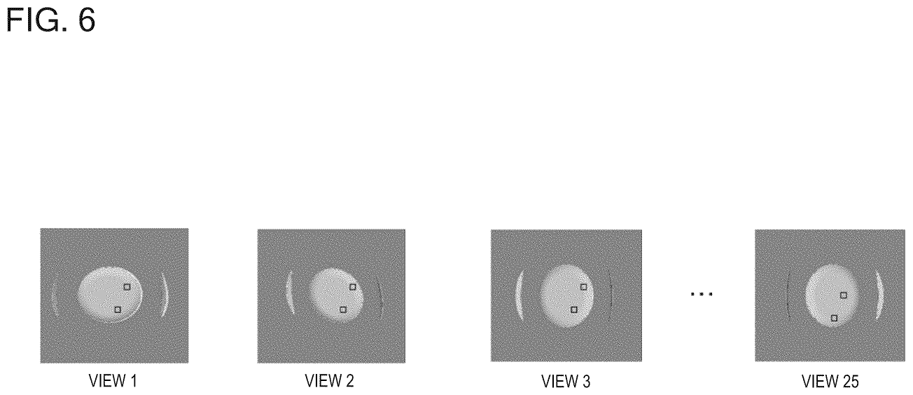

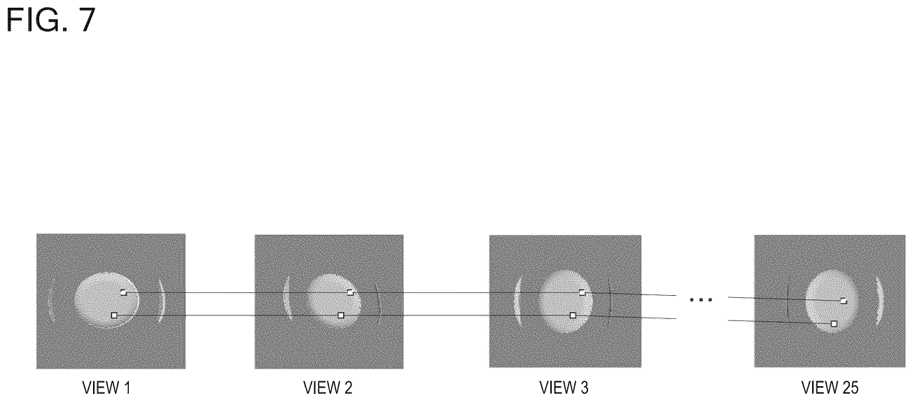

In step S4, the captured image of each of the views is masked with the generated mask image as illustrated in FIG. 6, and a defect candidate is detected for each of the views (the view 1 to the view 25) using a first AI. FIG. 7 illustrates the respective grouped same defect candidates in the views, and time-series data of a feature amount (contrast) that is arranged in order in correspondence with the plurality of different angles of view is generated from the respective images around the same defect candidates.

Next, the mask image generation processing according to the first embodiment will be described.

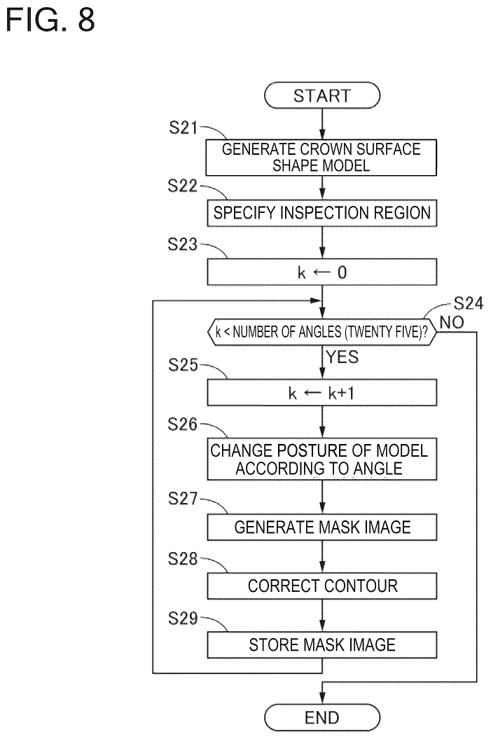

FIG. 8 is a flowchart illustrating a flow of the mask image generation processing according to the first embodiment.

In step S21, the shape model of the crown surface 7a is generated in an image coordinate system using three-dimensional data (facet information in 3D CAD) used in the design of the piston 7.

In step S22, each of the machined surfaces 11 and 12 or the as-cast surface 13 is specified as the inspection region.

In step S23, 0 is assigned to a second variable k.

In step S24, whether the second variable k is smaller than twenty five, which is the total number of angles, is determined. If the determination in step S24 is YES, the processing proceeds to step S25. If the determination in step S24 is NO, the present processing is ended.

In step S25, the second variable k is incremented. After the second variable k is incremented, the angle for which the mask image is generated is switched.

In step S26, the posture of the shape model of the crown surface 7a in the image coordinate system is changed according to the present angle. As a result, a virtual image when the crown surface 7a is imaged by a virtual camera at the present angle can be acquired.

In step S27, the inspection region is extracted in the virtual image, and the mask image is generated so as to mask a region other than the extracted inspection region as a mask region. In the mask image, the inspection region is transparently displayed, and the mask region is displayed using a single color distinguishable from the crown surface 7a and the background when superimposed on the actual captured image.

In step S28, a boundary (a contour) between the mask region and a non-mask region is corrected in a direction for reducing the non-mask region in the generated mask image. When the non-mask region is reduced, the non-mask region is reduced vertically and horizontally at equal reduction ratios. The reduction ratio is set to an optimum value according to, for example, a chucking error when the piston 7 is held by the hand 8 or a dimensional tolerance. Further, the non-mask region is reduced in such a manner that an envelope acquired when the inspection region in the virtual image is rotated by a predetermined angle (for example, 2 to) 3° about the center of the shape model of the crown surface 7a does not overlap the corrected non-mask region in the image coordinate system. For example, in the case of FIG. 5, one of two boundaries between the inspection region and the non-inspection region that is located outside the inspection region is moved outward, and the other boundary of them that is located inside the inspection region is moved inward.

In step S29, the generated mask image is stored as the mask image for the corresponding view.

Next, functions and advantageous effects of the first embodiment will be described.

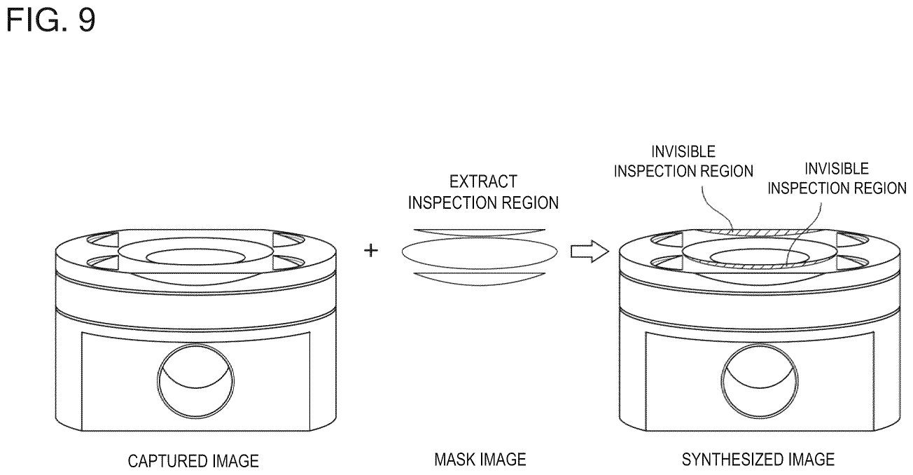

The conventional mask image generation method acquires a virtual image of an inspection region in an image coordinate system based on three-dimensional data of an imaging target and the position and the direction of the imaging target, and generates the mask image with the non-inspection region set to a region other than the inspection region. Therefore, when the mask image is superimposed on the actual captured image as illustrated in FIG. 9 (only the non-mask region is illustrated in FIG. 9 for better visibility), the conventional mask image generation method may lead to false recognition of an invisible inspection region (an unseen portion in the captured image) hidden due to unevenness of the surface of the imaging target, which is hatched in FIG. 9, i.e., the non-inspection region in the image as the inspection region in the synthesized image. Accordingly, the conventional mask image generation method may result in a failure to accurately generate the mask image especially when a three-dimensional curved surface is imaged while tilted.

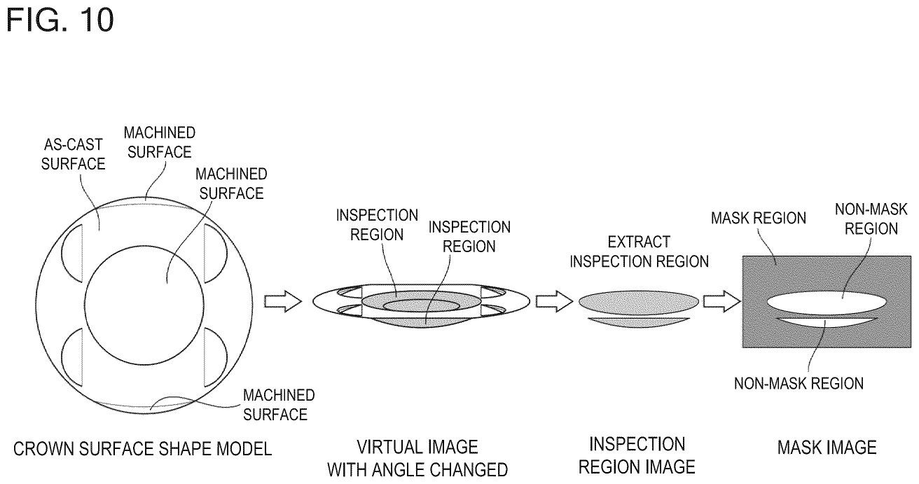

On the other hand, the mask image generation method according to the first embodiment acquires the virtual image when the crown surface 7a is imaged using the virtual camera by preparing the three-dimensional model of the crown surface 7a (the crown surface shape model) in the image coordinate system and changing the posture of the three-dimensional model according to each angle as illustrated in FIG. 10. The mask image is generated by subsequently extracting the inspection region from the virtual image and masking a region other than the inspection region. Then, no invisible region appears in the virtual image. Therefore, the mask image with a hidden portion, i.e., an invisible region in the inspection region removed (masked as the mask region) can be generated by generating the mask image from the virtual image. As a result, the mask image can be accurately generated especially when the three-dimensional curved surface is imaged while tilted.

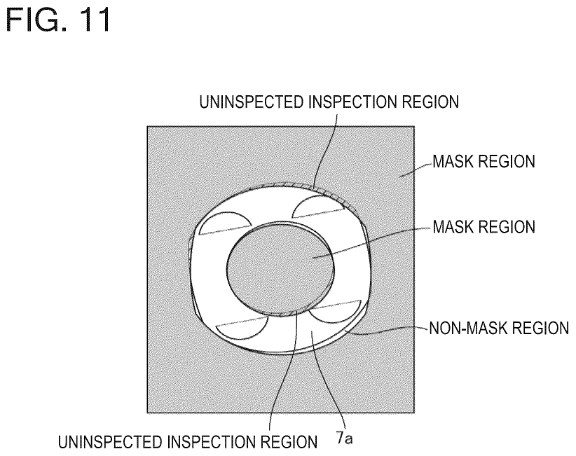

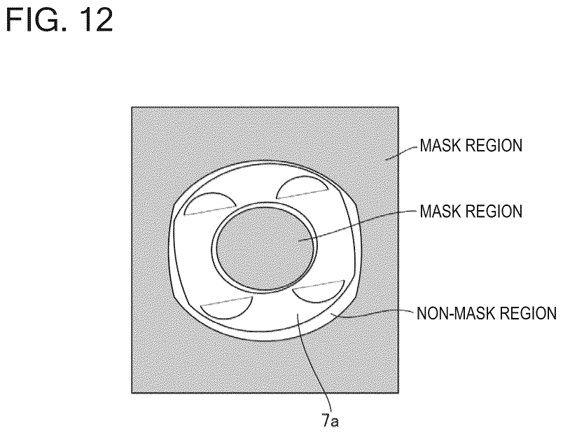

Then, the mask image is generated based on the design data of the crown surface 7a, and therefore the shapes and the positions of the mask region and the non-mask region are constantly kept the same for the same angle. On the other hand, in the captured image acquired by imaging the actual crown surface 7a, a variation occurs in the shape and the position of the crown surface 7a even for the same angle due to individual variability of the piston 7, a chucking error, or the like. This raises such a problem that a portion of the inspection region in the captured image that overlaps the mask region in the mask image (a hatched portion in FIG. 11) is not inspected as illustrated in FIG. 11 when the mask image is superimposed on the captured image. In view thereof, in the first embodiment, the mask image is generated by masking the non-inspection region (masking it as the mask region) from the virtual image after reducing the non-inspection region in the direction away from the inspection region in the virtual image. More specifically, a portion of the non-inspection region located outside the inspection region is reduced outward and a portion of the non-inspection region located inside the inspection region is reduced inward. FIG. 12 illustrates that the mask region is reduced in the mask image illustrated in FIG. 11, and an overlap between the inspection region and the mask region can be eliminated even with a variation present in the shape and the position of the crown surface 7a in the captured image as illustrated in FIG. 12. As a result, the inspection region can be prevented from remaining partially uninspected.

At this time, the non-inspection region is reduced vertically and horizontally at equal reduction ratios. Reducing the non-inspection region vertically and horizontally at different reduction ratios, if ever, increases a possibility that the inspection region and the mask region overlap each other in one of the vertical and horizontal directions that corresponds to a higher reduction ratio. Therefore, an overlap between the inspection region and the mask region can be effectively eliminated by reducing the non-inspection region vertically and horizontally at equal reduction ratios when reducing the non-inspection region.

Further, the non-mask region is reduced in such a manner that the envelope acquired when the inspection region in the virtual image is rotated by the predetermined angle about the center of the shape model of the crown surface 7a does not overlap the corrected non-mask region. A variation occurs in the angle of the crown surface 7a in the captured image due to a chucking error when the piston 7 is held by the hand 8. Therefore, an overlap between the inspection region and the mask region can be eliminated by setting the mask region while applying this variation in the angle.

In the first embodiment, the virtual image is generated for each of all the captured images corresponding to the twenty-five angles of view, and the mask image is generated for each virtual image. Due to that, the mask image can be generated with an invisible region removed (masked as the mask region) in all the captured images corresponding to the angles of view different from one another.

The twenty-five angles of view are acquired by fixing the camera 3 and rotating the piston 7 in such a manner that the second axis L2 inclined with respect to the predetermined first axis L1 is rotated about the first axis L1. Due to that, the crown surface 7a can be imaged at twenty-five kinds of angles of view without moving the camera 3.

In the visual inspection method according to the first embodiment, the surface of the crown surface 7a is inspected while the captured image acquired by imaging the crown surface 7a using the camera 3 is masked with the mask image generated using the mask image generation method according to the first embodiment. Due to that, the surface of the crown surface 7a can be inspected with the image thereof masked with the highly accurate mask image, and therefore a defect can be detected with improved accuracy.

In the visual inspection method according to the first embodiment, a defect on the surface of the crown surface 7a is detected based on the captured image masked with the mask image and the learning result of the machine learning conducted using the plurality of defective product sample images after the plurality of defective product sample images is generated by synthesizing the two-dimensional image of the defect shape, which is generated based on the defect model three-dimensionally formulated in advance, with the surface image of the crown surface 7a. Due to that, the defective product sample image can be generated so as to smoothly match an actual defect, and therefore the surface of the crown surface 7a can be inspected with improved accuracy. Further, the defective product samples do not have to be collected and stored because of the use of pseudo sample images. The time required to generate the defective product sample images is short compared with the time required to collect the defective product samples, and therefore the actual work time can be curtailed. Further, re-learning is unnecessary even for, for example, a change in the product model, replacement of the imaging device, and facility enhancement. Therefore, the inspection efficiency can be significantly improved. This effect is remarkable especially for a manufacturing line expected to take time to collect the number of defective samples, such as a manufacturing line having a low defective rate and a manufacturing line used to manufacture multiple products.

### OTHER EMBODIMENTS

Having described the embodiment for implementing the present invention, the specific configuration of the present invention is not limited to the configuration of the embodiment, and the present invention also includes a design modification and the like thereof made within a range that does not depart from the spirit of the present invention.

The embodiment has been described referring to the example in which a defect on the crown surface of the piston is detected as the inspection method, but the present invention can be applied to not only detecting a defect but also reading a two-dimensional code, a character, a mark, or the like on the surface of the imaging target, and can bring about similar advantageous effects to the embodiment.

The present invention shall not be limited to the above-described embodiment, and includes various modifications. For example, the above-described embodiment has been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2021-197538 filed on Dec. 6, 2021. The entire disclosure of Japanese Patent Application No. 2021-197538 filed on Dec. 6, 2021 including the specification, the claims, the drawings, and the abstract is incorporated herein by reference in its entirety.

### REFERENCE SIGNS LIST

1 visual inspection apparatus (inspection apparatus)
3 camera (imaging portion)
7 piston (imaging target)

1. A mask image generation method for generating a mask image for masking a partial region in a surface image corresponding to each of a plurality of angles after capturing the surface image of an imaging target at each of the plurality of angles while changing a relative posture between the imaging target and an imaging portion configured to image the imaging target, the mask image generation method comprising:
a step of specifying a first region of a surface and a plurality of specific postures in three-dimensional data indicating a shape of the imaging target;
a step of acquiring a plurality of virtual images when the imaging target is imaged by a virtual imaging portion while a posture of the three-dimensional data is changed to each of the plurality of specific postures; and
a step of generating the mask image from the virtual image and the first region.

2. The mask image generation method according to claim 1, wherein the step of generating the mask image includes generating the mask image by masking a second region other than the first region in each of the plurality of virtual images.

3. The mask image generation method according to claim 2, wherein the step of generating the mask image includes generating the mask image by masking the second region in each of the plurality of virtual images after reducing the second region in a direction away from the adjacent first region in each of the plurality of virtual images.

4. The mask image generation method according to claim 3, wherein the second region is reduced vertically and horizontally at equal reduction ratios when the second region is reduced in the direction away from the adjacent first region in each of the plurality of virtual images.

5. The mask image generation method according to claim 3, wherein the second region is reduced in such a manner that a portion thereof outside the first region is reduced outward and a portion thereof inside the first region is reduced inward.

6. The mask image generation method according to claim 3, wherein the second region is generated so as to cover a state in which the first region is rotated by a predetermined angle.

7. The mask image generation method according to claim 6, wherein the second region is generated so as to comply with an envelope acquired when the three-dimensional data is rotated.

8. The mask image generation method according to claim 2, wherein the step of generating the mask image includes generating the mask image by masking the second region other than the first region and a hidden portion of the first region in each of the plurality of virtual images.

9. An inspection method comprising:
a step of generating a mask image using the mask image generation method according to claim 1 when generating the mask image for masking a partial region in a surface image corresponding to each of a plurality of angles after capturing the surface image of an imaging target at each of the plurality of angles while changing a relative posture between the imaging target and an imaging portion configured to image the imaging target; and
a step of inspecting a surface of the imaging target while masking an actual image acquired by imaging the imaging target using the imaging portion with the mask image.

10. The inspection method according to claim 9, wherein a defect on the surface is detected by applying machine learning to the masked actual image.

11. The mask image generation method according to claim 1, wherein the virtual image is generated for each of all the plurality of specific postures.

12. The mask image generation method according to claim 1, wherein the plurality of specific postures is acquired by fixing the imaging portion and rotating the imaging target in such a manner that a second axis inclined with respect to a predetermined first axis is rotated about the first axis.

13. An inspection apparatus configured to inspect a surface of an imaging target by capturing a surface image of the imaging target at each of a plurality of angles while changing a relative posture between the imaging target and an imaging portion configured to image the imaging target,
the inspection apparatus being configured to
hold three-dimensional data indicating a shape of the imaging target,
specify a first region of the surface and a plurality of specific postures in the three-dimensional data,
acquire a plurality of virtual images when the imaging target is imaged by a virtual imaging portion while a posture of the three-dimensional data is changed to each of the plurality of specific postures,
generate a mask image that masks a second region other than the first region in each of the plurality of virtual images, and
inspect the surface of the imaging target while masking an actual image acquired by imaging the imaging target using the imaging portion with the mask image.

14. The inspection apparatus according to claim 13, wherein the mask image is generated by masking the second region in each of the plurality of virtual images after reducing the second region in a direction away from the adjacent first region in each of the plurality of virtual images.

15. The inspection apparatus according to claim 13, wherein the mask image is generated by masking the second region other than the first region and a hidden portion of the first region in each of the plurality of virtual images.
